(19) United States
(12) Patent Application Publication
(10) Pub. No.: US 2015/0357177 A1
(43) Pub. Date: Dec. 10, 2015

(54) RUN-UP TIME IN AMALGAM DOSED COMPACT FLUORESCENT LAMPS

(71) Applicant: GENERAL ELECTRIC COMPANY, Schenectady, NY (US)

(72) Inventors: Loránd Lehel Tóth, Budapest (HU); Jácint GERGELY, Budapest (HU); Sándor Lukács, Veroce (HU); Gábor Szabó, Budapest (HU)

(21) Appl. No.: 14/296,000

(22) Filed: Jun. 4, 2014

(51) Int. Cl. H01J 61/24; H01J 61/06

(52) U.S. Cl. CPC H01J 61/24; H01J 61/06

(57) ABSTRACT

In some embodiments, a fluorescent lighting device includes an arc tube; an amalgam flag including two opposing planar surfaces within the arc tube, the planar surfaces being adjacent to each other along a first edge of the planar surfaces and spaced apart from each other along a second edge of the planar surfaces; a quantity of amalgam deposited on the planar surfaces of the amalgam flag; and an electrode disposed within the arc tube to, at least in part, heat the quantity of amalgam when energized.

### BACKGROUND

The present disclosure relates, generally, to a low pressure mercury-vapor gas-discharge lamp and more particularly to a compact fluorescent lamp having an amalgam for emitting mercury during at least a starting period to reduce a run-up time in the fluorescent lamp.

Low pressure mercury-vapor gas-discharge lamps, such as compact fluorescent lamps (CFLs), typically include an arc tube filled with a gas containing low pressure mercury vapor and noble gases. Fluorescent lamps may exhibit run-up time when the lamps are initially turned on. The run-up time refers to the time between the application of power to the lamp, and the time when the light output from the lamp reaches a specified percentage of stable light output. At startup the lamp's output may gradually increase from an initial, low level to a higher, more stable level (e.g., 80%, 90%, etc. of stabilized light output from the lamp). Run-up time for CFLs typically includes the first few minutes of operation of the lamp. However, an appreciable run-up time is generally undesirable. Therefore, there exists a need and a desire to minimize the run-up time exhibited by fluorescent lamps.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is an illustrative depiction of a portion of a compact fluorescent lamp (CFL);

FIG. 2 is an illustrative depiction of a portion of a CFL including an open amalgam flag, according to some embodiments herein;

FIG. 3 is a comparative example chart illustrating lamp run-up times;

FIG. 4 is an example chart illustrating lamp run-up times for CFLs, in accordance with some embodiments herein;

FIG. 5 is a comparative example table listing of lamp run-up times of the lamps in FIG. 3;

FIG. 6 is an example table listing of lamp run-up times for the CFLs in FIG. 4, in accordance with some embodiments herein;

FIG. 7 is a comparative example plot of lamp run-up times of the lamps in FIG. 3;

FIG. 8 is an example plot of lamp run-up times for the CFLs in FIG. 4, in accordance with some embodiments herein;

FIG. 9 is a comparative example boxplot of the lamp run-up times of FIG. 3;

FIG. 10 is an example boxplot of lamp run-up times for the CFLs in FIG. 4, in accordance with some embodiments herein;

FIG. 11 is a tabular listing of analytical data relating to aspects of the lamps depicted in FIGS. 3 and 4;

FIG. 12 is a boxplot of analytical data relating to aspects of the lamps depicted in FIGS. 3 and 4;

### DETAILED DESCRIPTION

The present disclosure relates to fluorescent lamps and devices and methods for reducing run-up time in fluorescent lamps. The present disclosure will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present disclosure. It may be evident, however, that aspects of the present disclosure can be practiced without these specific details. Additionally, other embodiments are possible and the invention(s) herein are capable of being practiced and carried out in ways other than as explicitly described. The terminology and phraseology used in describing the present disclosure is used for the purpose of promoting an understanding of the present disclosure.

Some CFLs may contain a main amalgam and an auxiliary amalgam. The main amalgam is provided in the lamp to control the mercury vapor pressure during lamp operation, except for the start-up period. The auxiliary amalgam may be provided to control and influence the mercury vapor during the start-up period.

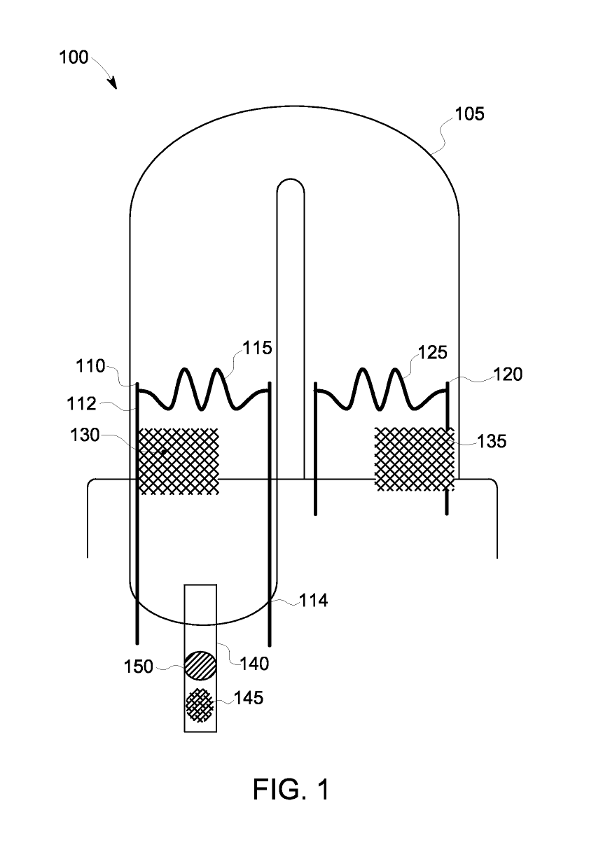

FIG. 1 is a highly schematic illustrative depiction of a portion of a CFL 100. CFL 100 includes an arc tube 105. Arc tube 105 may have a spiral or other configuration without limitation herein. Arc tube 105 may typically be attached to a base (not shown), such as a screw base. In some embodiments, lamp 100 may not be a CFL but instead of it an alternative be another style of fluorescent lamp that includes, in accordance with some embodiments herein, an amalgam on an open amalgam flag as will be described in greater detail hereinbelow.

CFL 100 includes a first electrode 110 and a second electrode 120. Electrodes 110 and 120 may each comprise stems (e.g., 112 and 114) coupled together with a filament 115, 125. The electrodes' stems may be operatively coupled to a power supply or other power source (not shown) compatible with CFL 100 that selectively energizes electrodes 110, 120 during operation of the lamp.

CFL 100 further includes a main amalgam 145 that is located within an exhaust discharge tube 140 that extends from arc tube 105. In some embodiments, the main amalgam provides a source of mercury to support sustained operation of CFL 100. In some designs, a glass ball 150 is provided in exhaust tube 140, although some embodiments do not include a glass ball. A heating element may be provided, in some embodiments, in close proximity to main amalgam 145 to heat the main amalgam.

In an effort to reduce and control the run-up time exhibited by CFL 100 a first amalgam flag 130 and a second amalgam flag 135 may be provided as illustrated in FIG. 1. Each amalgam flag is located in close proximity to the filament 115, 125 of one of the electrodes 110 and 120. The exact size and location of amalgam flags 130 and 135 may be determined and controlled in an effort to control the effectiveness of the amalgam flags in reducing the run-up time of lamp 100.

Referring to amalgam flags 130 and 135 of FIG. 1, the amalgam flags therein are substantially planar and sheet-like in configuration. That is, the planar surfaces of the amalgam flags have opposing faces on either side of the amalgam flag that are adjacent to each other. Accordingly, there may be essentially nothing in the space between the opposing faces of each of the amalgam flags 130 and 135.

Amalgam flags 130 and 135 may each be substantially planar and comprise a thermally conductive material. In some embodiments, the planar surface of amalgam flags 130, 135 may comprise a mesh-like material. Amalgam flags 130 and 135 may each have a quantity of amalgam deposited thereon. The amalgam deposited on amalgam flags 130 and 135 may be referred to herein as an auxiliary amalgam. The auxiliary amalgam may emit mercury during the start-up period. The auxiliary amalgam is heated by the nearby electrode (i.e., cathode) after ignition and emits mercury to make up for the lack of mercury vapor during the start-up period. In some embodiments, an amalgam flag having auxiliary amalgam deposited thereon is attached to a stem of each cathode in an effort to improve start-up characteristics of lamp 100.

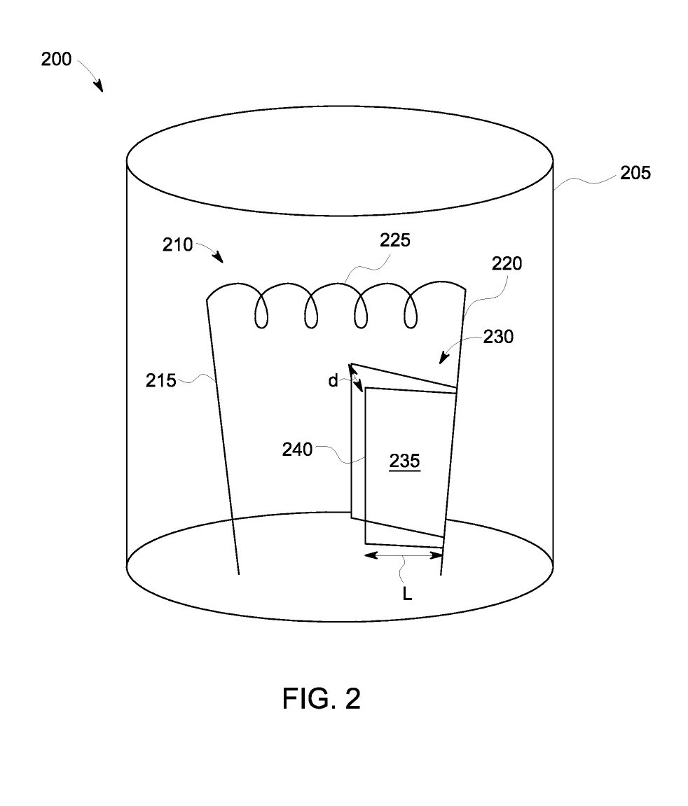

FIG. 2 is a highly schematic illustrative portion of a CFL 200 in accordance with some embodiments herein. In particular, CFL 200 includes an arc tube 205. Located within arc tube 205 is an electrode 210. Electrode 210 includes stems 215, 220 and filament 225 located between and coupled to stems 215, 220. Electrode stems 215 and 220 may be coupled, either directly or indirectly, to a power supply or other source of electrical energy (not shown).

In some embodiments, lamp 200 may include a second electrode and a second amalgam flag at an opposite end of arc tube 205. For purposes related to clarity, the lamp depicted in FIG. 2 does not explicitly illustrate the second electrode and second amalgam flag in an effort to keep the drawings herein clear, concise, and non-repetitive. However, reference to both FIGS. 1 and 2 will provide an understanding of a lamp 200 with the second electrode and second amalgam flag.

Lamp 200 further includes an amalgam flag 230. Amalgam flag 230 is, in some instances, referred to as an open flag herein. Amalgam flag 230 includes two opposing planar surfaces 235 and 240 located within arc tube 205. In some embodiments, the planar surfaces 235 and 240 may be adjacent to each other along a first edge of the planar surfaces and spaced apart from each other along a second edge of the planar surfaces. Such a configuration results in amalgam flag 230 having an “open” configuration wherein the opposing planar surfaces 235 and 240 are at least partially spaced apart. For example, the opposing planar surfaces of amalgam flag 230 are depicted as being spaced apart a distance or length “d”. In some embodiments, the distance “d” may be about at least 0.35 mm. In some embodiments, a quantity of amalgam is deposited on the planar surfaces 235 and 240 of amalgam flag 230.

In some aspects, the opposing planar surfaces 235, 240 form a junction along the first edge of the planar surfaces where the planar surfaces are adjacent to each other. In some embodiments, a wire or stem 220 is located along an inside face of the junction formed by the adjacent opposing planar surfaces. In some embodiments, amalgam flag 230 may be affixed to electrode stem (wire) 220 at a fixed location.

In some embodiments, electrode 210 of CFL 200 includes stem wire 220. Stem wire 220 has a diameter d_{w} located inside and adjacent the junction formed along the first edge of the opposing planar surfaces 235, 240. Although not specifically depicted in the Figures, diameter d_{w} of a wire (e.g., stem wire 220) may be readily ascertained by any person of ordinary skill in the field. In some embodiments, planar surfaces 235, 240 are substantially the same size and extend a distance L from the first edge to the second edge.

In some embodiments, a minimum value and a maximum value for the distance d between the opposing planar surfaces 235, 240 along their second edge (as illustrated in FIG. 2) is defined as a function of the distance L between the first edge and the second edge. In some aspects, a function that defines a minimum value and a maximum value for the distance d between the opposing planar surfaces along the second edge is represented as d_{w}/L≦(d/L)≦2, where d_{w} is the diameter of the wire (e.g., stem wire 220) located inside and adjacent the junction formed along the first edge of the adjacent opposing planar surfaces 235, 240.

In some aspects, the auxiliary amalgam deposited on open amalgam flag 230 may emit mercury during the start-up period. The auxiliary amalgam thereon is heated by the energized filament 225 of nearby electrode 210 after ignition (i.e., turn-on) and emits mercury to make up for a lack of free mercury vapor during the start-up period.

In some embodiments, the exact size and location of amalgam flags 235, 240 of open amalgam flag 230 may be predetermined and controlled in an effort to control the effectiveness of the open amalgam flags herein in reducing the run-up time of lamp 200.

In some aspects, the open amalgam flag(s) disclosed herein provide an increase in the active surface of an amalgam flag as compared to a conventional amalgam flag having a closed design (i.e., no opposing planar surfaces separated in spaced apart configuration). For example, for a given size and given surface area of an amalgam flag, the active surface of the open amalgam flag herein increases the active surface by “opening” the flag.

In some embodiments, the location of the open amalgam flags herein may be maintained at a specific distance and/or orientation to the heating filament of the nearby electrode for one or more design and/or operational considerations. Given such constraints, it is noted that the open amalgam flags herein operate to efficiently reduce the run-up time of the lamp compared to a similar lamp having a “closed” amalgam flag(s). Accordingly, a run up time for a lamp having open amalgam flags as disclosed herein is decreased as compared to a similar lamp having a “closed” amalgam flag having a single planar surface, where the single planar surface of the “closed” amalgam flag is sized similar to each of the two opposing planar surfaces of the open amalgam flag.

In some embodiments, the run-up time of a lamp that includes the open amalgam flag design disclosed herein may be reduced as compared to a similar lamp that uses “closed” amalgam flags by at least about 15 seconds. In some instances, the run-up time may be decreased by at least about 30 seconds.

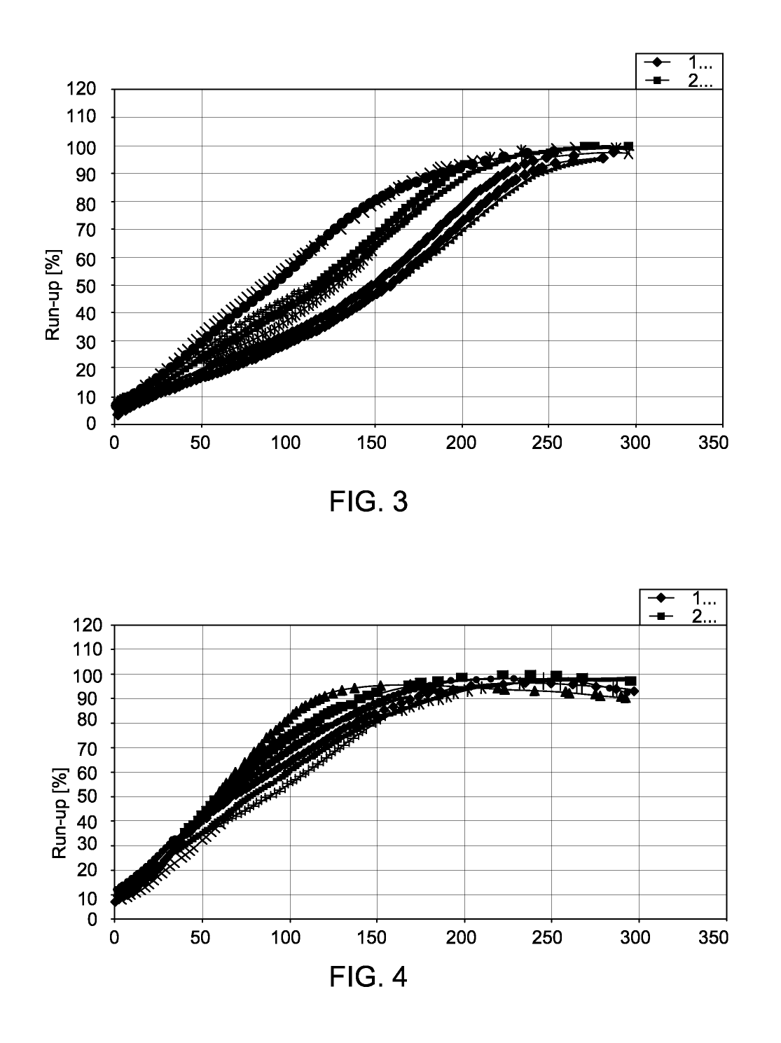

FIGS. 3-12 include comparative charts and tables demonstrating the effectiveness of a lamp having open amalgam flags as disclosed herein in reducing the run-up as compared to similar lamps having “closed” amalgam flags. In particular, the charts and tables include run-up results for a PAR38 120V 2700K lamp having a closed amalgam flag and a PAR38 120V 2700K lamp having an open amalgam flag. As indicated in FIGS. 3-12, the lamp having the open amalgam flag had an improved run-up time (i.e., lower time) and a decreased standard variation regarding the run-up time.

FIG. 3 is a chart showing run-up time for ten PAR38, 120V, 2700K lamps having a closed amalgam flag, with time measured along the horizontal axis and the percentage of stable light output measured on the vertical axis. FIG. 4 shows measurements for ten PAR38, 120V, 2700K lamps having an open amalgam flag, in accordance with some embodiments herein. As seen from a comparison of FIGS. 3 and 4, it is clear that the lamps with the open amalgam flag have an improved run-up. Although there is an inset legend for each of FIGS. 3 and 4, showing diamonds and squares, it should be noted that all of the ten lamps tested in FIG. 3 were PAR38 120V 2700K lamps having a closed amalgam flag, and no significance should be ascribed to the differences between curves with diamonds and curves with squares, etc. Likewise, all of the ten lamps tested in FIG. 4 were PAR38 120V 2700K lamps having an open amalgam flag in accordance with embodiments, and no significance should be ascribed to the differences between curves with diamonds and curves with squares, etc.

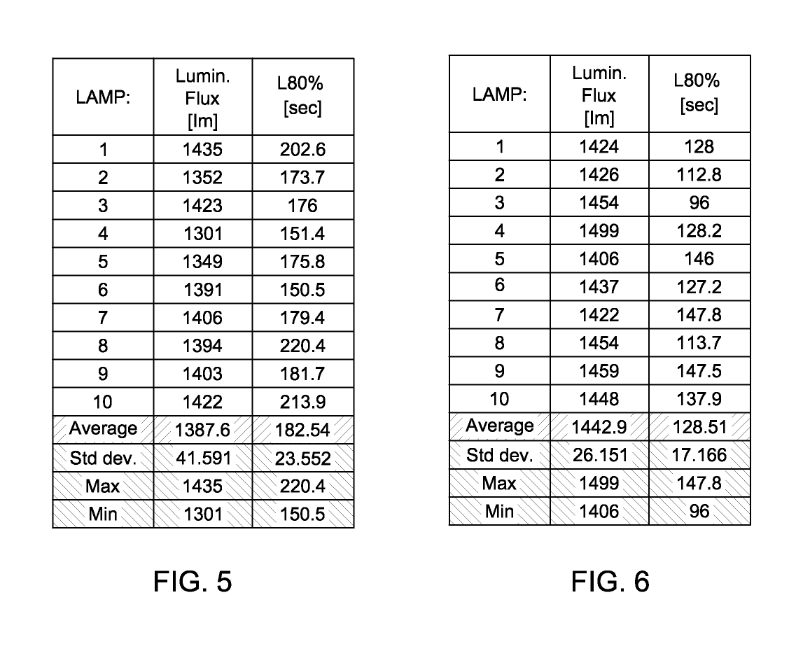

FIG. 5 is a tabular listing of the measurements for the lamps of FIG. 3 having a closed amalgam flag. FIG. 6 is a tabular listing of the measurements for the lamps of FIG. 4 having an open amalgam flag, in accordance with some embodiments disclosed herein. The tables of FIGS. 5 and 6 include the measurements for the individual lamps as well as summary data such as averages, standard deviation, maximum, and minimum values. FIG. 5 and FIG. 6 each describe the time (in seconds) needed to reach L80%.

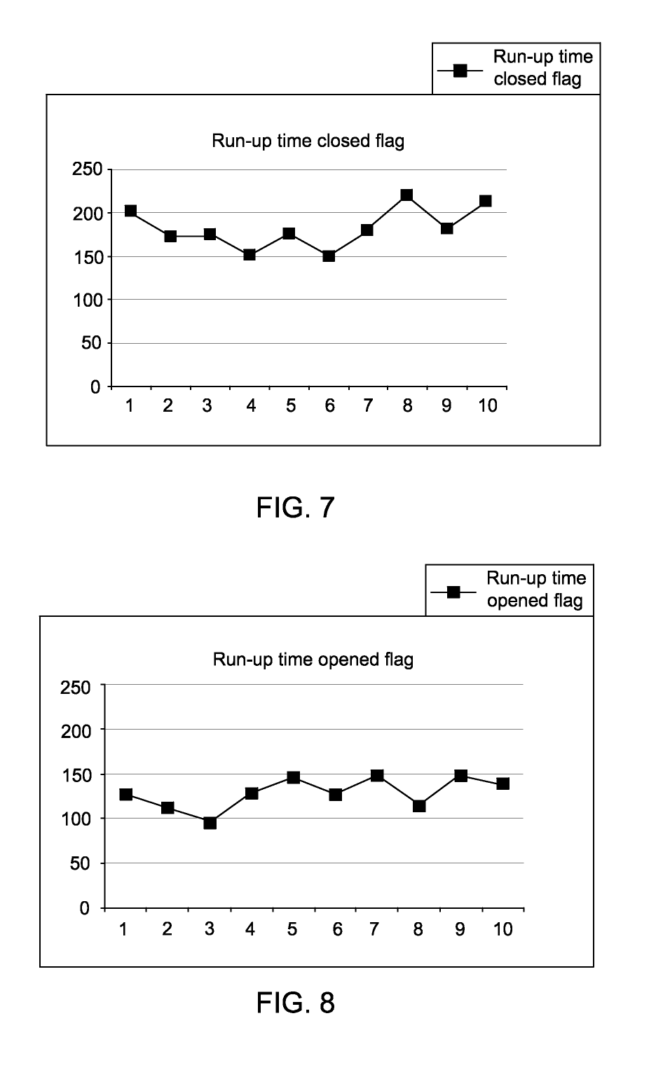

FIG. 7 is a plot of the run-up times for the lamps of FIG. 3 having a closed amalgam flag. FIG. 8 is a plot of the run-up times for the lamps of FIG. 4 having an open amalgam flag, in accordance with some embodiments disclosed herein. Each of FIG. 7 and FIG. 8 describe run-up time in seconds, on the vertical axis.

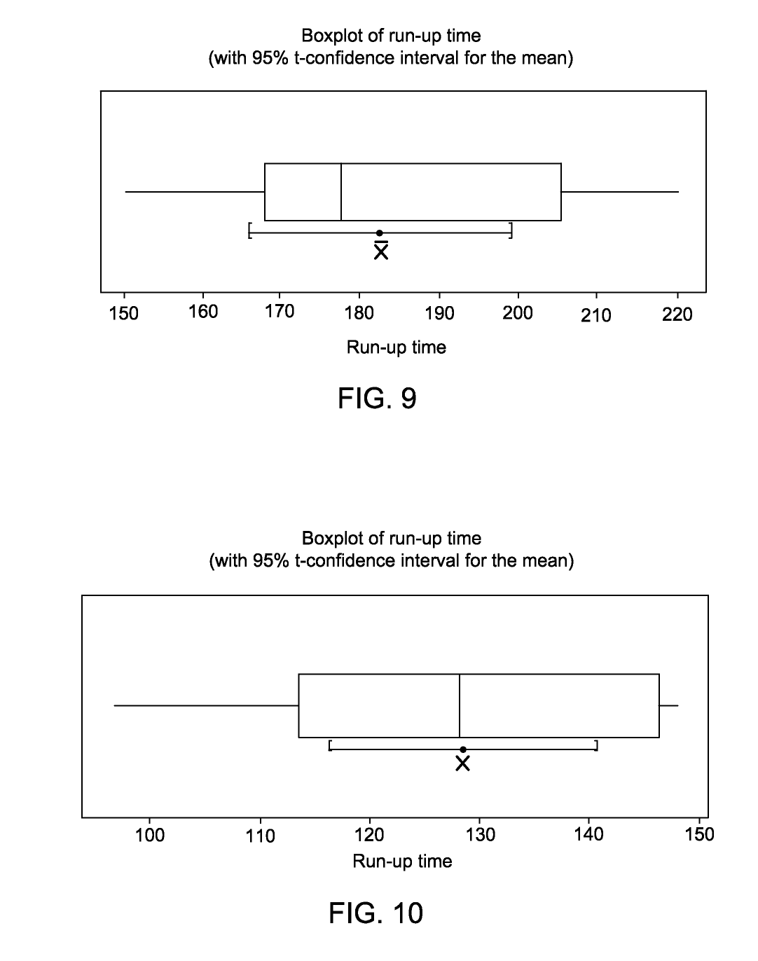

FIG. 9 is a boxplot of the data in FIG. 7, corresponding to the lamps of FIG. 3 having a closed amalgam flag. FIG. 10 is a boxplot of the data in FIG. 8 that corresponds to the lamps of FIG. 4, in accordance with some embodiments disclosed herein. Each of FIG. 9 and FIG. 10 describe run-up time in seconds, on the horizontal axis.

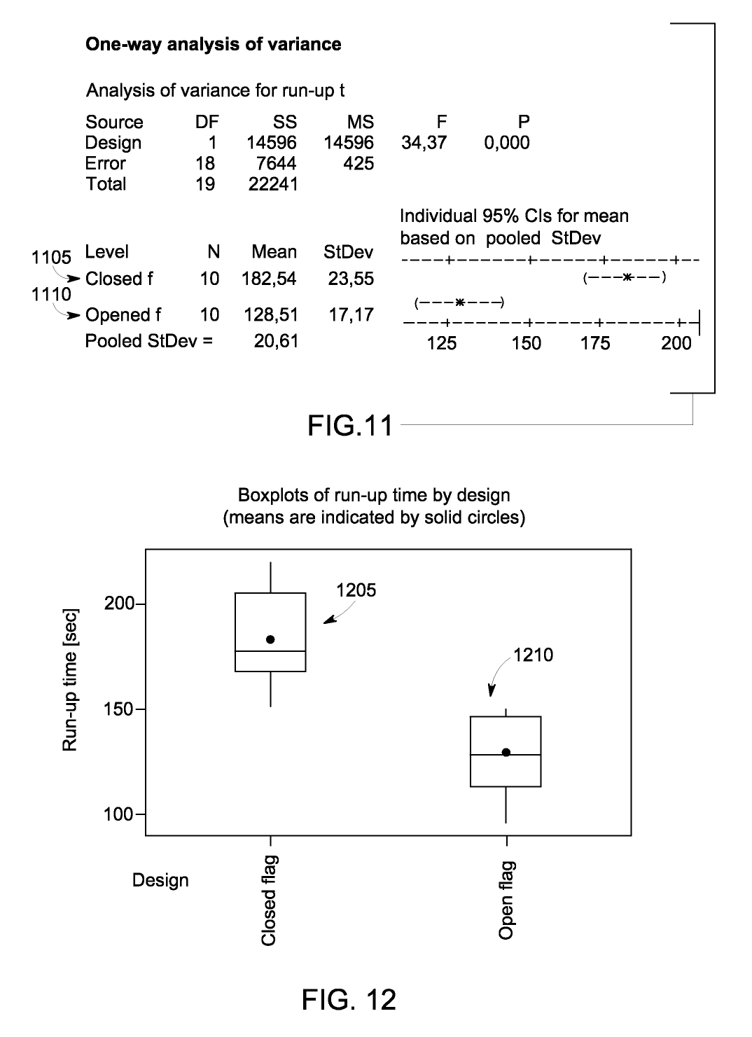

FIG. 11 is a tabular listing of data related to the comparative data in the charts and tables of FIGS. 3-10. FIG. 11 relates to a one-way analysis of variance, including the mean and standard of deviation of the measurements for the lamps with the closed amalgam flag at 1105 and the mean and standard of deviation of the measurements for the lamps with the open amalgam flag at 1110. (Note that in FIG. 11, the “Mean” and “StDev” values are run-up times in seconds, with a “comma” delineating units place from decimal places). FIG. 12 is a boxplot of the data in FIG. 11.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A fluorescent lighting device, comprising:
an arc tube;
an amalgam flag including two opposing planar surfaces within the arc tube, the planar surfaces being adjacent to each other along a first edge of the planar surfaces and spaced apart from each other along a second edge of the planar surfaces;
a quantity of amalgam deposited on the planar surfaces of the amalgam flag; and
an electrode disposed within the arc tube proximate the amalgam flag.

2. The fluorescent lighting device of claim 1, wherein the electrode comprises a filament and further comprises a stem wire at least partially located at a junction formed along the first edge of the opposing planar surfaces of the amalgam flag.

3. The fluorescent lighting device of claim 2, wherein the planar surfaces extend a distance L between the first edge and the second edge, and wherein a minimum value and a maximum value for a distance d between the opposing planar surfaces along the second edge is defined as a function of the distance L between the first edge and the second edge.

4. The fluorescent lighting device of claim 3, wherein the stem wire comprises a diameter d_{w} and wherein the function is d_{w}/L≦(d/L)≦2.

5. The fluorescent lighting device of claim 1, wherein a run up time for the device is decreased compared to a fluorescent lighting device having an amalgam flag that includes a single planar surface sized substantially the same as each of the two opposing planar surfaces.

6. The fluorescent lighting device of claim 5, wherein the run up time for the device is decreased by at least about 15 seconds.

7. The fluorescent lighting device of claim 1, further comprising:
a second amalgam flag including two opposing planar surfaces within the arc tube, the planar surfaces of the second amalgam flag being adjacent to each other along a first edge thereof and spaced apart from each other along a second edge thereof;
a second quantity of amalgam deposited on the planar surfaces of the second amalgam flag; and
a second electrode disposed within the arc tube proximate to the second amalgam flag.

8. The fluorescent lighting device of claim 7, wherein the second electrode comprises a stem wire at least partially located at a junction formed along the first edge of the planar surfaces of the second amalgam flag.

9. The fluorescent lighting device of claim 1, further comprising a power supply circuit operatively coupled to the electrode.

10. The fluorescent lighting device of claim 1, further comprising an exhaust tube extending from the arc tube.

11. The fluorescent lighting device of claim 10, wherein amalgam is deposited in the exhaust tube.

12. The fluorescent lighting device of claim 1, wherein the electrode comprises a filament to heat the amalgam deposited on the planar surfaces of the amalgam flag.

13. The fluorescent lighting device of claim 7, wherein the second electrode comprises a filament to heat the amalgam deposited on the planar surfaces of the second amalgam flag.
